(19) United States
(12) Patent Application Publication
(10) Pub. No.: US 2024/0078437 A1
(43) Pub. Date: Mar. 7, 2024

(54) METHOD FOR TRAINING A GENERATIVE ADVERSARIAL NETWORK

(71) Applicant: Robert Bosch GmbH, Stuttgart (DE)

(72) Inventors: Sebastian Ziesche, Leonberg (DE); Martin Schiegg, Korntal-Muenchingen (DE)

(21) Appl. No.: 18/452,740

(22) Filed: Aug. 21, 2023

(30) Foreign Application Priority Data
Sep. 6, 2022 (DE) 10 2022 209 256.2
Sep. 16, 2022 (DE) 10 2022 209 787.4

(51) Int. Cl. G06N 3/094

(52) U.S. Cl. CPC G06N 3/094

(57) ABSTRACT

A method for training a generative adversarial network. The method includes: iteratively training the generative adversarial network based on the training data, the training of the generative adversarial network including an alternating training of the generator and the discriminator based on the training data, the training of the generator including a training the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of the additional realism assessment of at least one specific feature derived from the corresponding data including an application of a deterministic function.

### CROSS REFERENCE

The present application claims the benefit under 35 U.S.C. § 119 of German Patent Application Nos. DE 10 2022 209 256.2 filed on Sep. 6, 2022, and DE 10 2022 209 787.4 filed on Sep. 16, 2022, which are both expressly incorporated herein by reference in their entireties.

### FIELD

The present invention relates to a method for training a generative adversarial network, particularly a method for training a generative adversarial network to model a profile for controlling a controllable system, which is more stable compared with conventional methods for training a corresponding generative adversarial network and with which computing time and resources for training the generative adversarial network may be saved.

### BACKGROUND INFORMATION

A generative adversarial network is generally understood to be a model of machine learning that is capable of generating data. Such generative adversarial networks are used, for example, to create images from a sketch, to generate a realistic image from text, to model behavioral and/or movement patterns within a timeframe, or to model profiles for controlling a controllable system, the profiles specifying the evolution or the settings of at least one controllable parameter over time or over a certain period of time.

Specifically, a generative adversarial network is understood to be an algorithm of machine learning based on two interconnected neural networks. The first neural network, the generator, generates data which initially consist only of random statistical noise. The second neural network, the discriminator, analyzes or classifies the data generated by the first neural network, the discriminator being trained with true or real data, known as ground truth information, to enable it to evaluate these data. The generative adversarial network is usually trained by way of an iterative procedure, the generator and the discriminator being trained alternately or in each iteration step. The aim is to ensure that the trained generative adversarial network is subsequently able to mimic real-world conditions as accurately as possible.

In addition, in some generative adversarial networks, the discriminator is designed also to evaluate expert knowledge or specific features that characterize a precisely defined situation. In particular, the discriminator is designed to verify to what extent true or real data corresponding to a specific feature match corresponding values derived from profiles generated by the generator, it being possible also to incorporate the corresponding verification results into a corresponding cost function for training the generator, and this additional verification usually also being based on a neural network.

An additional neural network is usually provided in this case to verify a specific feature. However, the provision of the additional neural network adds a further machine learning algorithm requiring training, and this makes the overall training of the generative adversarial network less stable and less reproducible. It also results in longer training times and an additional resource consumption for training the generative adversarial network. There is thus a need for methods for training a generative adversarial network in which the discriminator is designed also to evaluate expert knowledge and with which at the same time the resource consumption for training the corresponding generative adversarial network may be reduced.

A method for training a generative adversarial network is described in European Patent No. EP 3 745 309 A1 in which explanatory information specifying the basis on which the discriminator arrives at its classification may be provided to the generator during training. In particular, this explanatory information may be provided in the form of one or more attention masks, which may be generated by the discriminator and may identify the parts of a given input instance that contribute to the classification of the input instance by the discriminator.

An object of the present invention is to provide a method for training a generative adversarial network in which the discriminator is designed also to evaluate expert knowledge and with which the resource consumption for training the corresponding generative adversarial network may be reduced.

This object may be achieved by a method for training a generative adversarial network according to the features of the present invention.

In addition, the object may also be achieved by a system for training a generative adversarial network according to the features of the present invention.

### SUMMARY

According to one specific embodiment of the present invention, this object may be achieved by a method for training a generative adversarial network, the generative adversarial network having a generator and a discriminator, and the method comprising a provision of training data for training the generative adversarial network and an iterative training of the generative adversarial network based on the training data, the training of the generative adversarial network including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of an additional realism assessment of at least one specific feature derived from the corresponding data including an application of at least one deterministic function.

A realism assessment is understood here to be an estimation or appraisal of the authenticity of the corresponding data or distribution.

Deterministic functions are understood here to be functions which, in contrast to neural networks, have no or only very few trainable parameters. The application of these functions instead of neural networks leads to faster processing and more robust training of the generative adversarial network.

For example, the deterministic function may be designed to output the value 1 if the at least one specific feature deviates from the corresponding feature derived from the corresponding data by less than a predefined limit or is very similar to it, and otherwise a value that is less than 1 and tends closer to zero as the deviation increases. Moreover, a separate deterministic function may be provided for each of the at least one specific feature.

The application of at least one deterministic function has the advantage that it does not have to be trained separately, and so the overall training process becomes more stable and reproducible. This in turn results in shorter training times and a lower resource consumption for training the generative adversarial network. Moreover, compared with conventional methods for training such a generative adversarial network, a greater accuracy is achieved with the same training data, especially since, by selecting specific features that are of interest, a user is able to adjust the distribution of these features particularly well to the distribution of the data.

In summary, therefore, according to an example embodiment of the present invention, a method is provided for training a generative adversarial network in which the discriminator is designed also to evaluate expert knowledge and with which at the same time the resource consumption for training the corresponding generative adversarial network may be reduced.

The application of at least one deterministic function for each of the at least one specific feature may include an evaluation of a distance between at least one distribution characterizing the corresponding specific feature and at least one distribution characterizing the corresponding feature derived from the corresponding data.

The evaluation of a distance between the at least one real feature and the corresponding feature derived from the corresponding data means that a distance between at least one distribution characterizing the specific feature and at least one distribution characterizing the corresponding feature derived from the corresponding data is determined or approximated, wherein, once again, the value 1 may be output, for example, if the distribution characterizing the specific feature and the distribution characterizing the corresponding feature derived from the corresponding data are very close, and otherwise a value that is less than 1 and tends closer to zero as the deviation increases may be output.

Since algorithms for determining or approximating a distance between distributions are conventional, the application of the at least one deterministic function may thus be based on conventional and commonly used algorithms without the need for laborious and complex adjustments.

According to an example embodiment of the present invention, the method may further include, for each of the at least one specific feature, storing at least one distribution or probability distribution for the corresponding specific feature, the at least one probability distribution for the corresponding feature being adjusted in each iteration step based on the corresponding data in order to generate at least one adjusted probability distribution, and, for each of the at least one specific feature, the performance of the additional realism assessment including an evaluation of a distance between the corresponding at least one adjusted probability distribution and an empirical probability distribution of the at least one specific feature.

A probability distribution is understood here to be a distribution which assigns to each value a probability that the value will occur.

Furthermore, an empirical probability distribution is understood to be a distribution derived from all training data which indicates how probable it is that a measured value from a random sample will at most be a certain size.

According to an example embodiment of the present invention, the adjustment of the at least one probability distribution may further include, for each of the at least one specific feature, a weighting of the at least one probability distribution and/or a smoothing of the at least one probability distribution based on the corresponding data and/or based on training data processed in the corresponding iteration step.

Storing at least one probability distribution in this way proves advantageous particularly when training the generative adversarial network on the basis of batches or subsets of the training data, since values for the at least one specific feature derived purely from the corresponding batch are possibly imprecise or inadequate.

Moreover, according to an example embodiment of the present invention, the generative adversarial network may be trained to generate vehicle variables of a motor vehicle, or the training data may be sensor data representing corresponding vehicle variables.

A sensor, which is also referred to as a detector, (measuring) pickup or (measuring) probe, is understood here to be a technical component that is capable of recording certain physical or chemical properties and/or the material characteristics of its environment, either qualitatively, or quantitatively as a measured variable.

The method for training the generative adversarial network may thus be based on conditions outside the actual data processing system on which the generative adversarial network is trained.

The vehicle variables may be a speed of a motor vehicle, an acceleration of a motor vehicle, or vehicle emissions, for example.

A further specific embodiment of the present invention also provides a method for controlling a controllable system, the method comprising a modeling of a profile for controlling the controllable system, the profile being modeled by a generative adversarial network and the generative adversarial network having been trained using a method for training a generative adversarial network as described above, and a control of the controllable system based on the modeled profile for controlling the controllable system.

A controllable system is understood here to be a system, particularly a robotic system, which is controllable in such a way that a state of the system or of one or more components of the system may be transferred in finite time, by applying suitable actuating signals or by applying suitable tasks or actions, into a new state, particularly from a selected input state into a selected output state. The controllable system may be a motor vehicle, for example.

A method according to an example embodiment of the present invention is thus provided for controlling a controllable system, which method is based on a generative adversarial network that was trained using a method for training a generative adversarial network, the discriminator being designed also to evaluate expert knowledge, and at the same time the resource consumption for training the corresponding generative adversarial network being able to be reduced. The application of at least one deterministic function in the corresponding discriminator has the advantage that it does not have to be trained separately, and so the overall training process becomes more stable and reproducible. This in turn results in shorter training times and a lower resource consumption for training the generative adversarial network. Moreover, compared with conventional methods for training such a generative adversarial network, a greater accuracy is achieved with the same training data, especially since, by selecting specific features that are of interest, a user is able to adjust the distribution of these features particularly well to the distribution of the data.

Furthermore, a further specific embodiment of the present invention also provides a system for training a generative adversarial network, the generative adversarial network having a generator and a discriminator, and the system comprising a provision unit, which is designed to provide training data for training the generative adversarial network, and a training unit, which is designed to train the generative adversarial network iteratively based on the training data, the training of the generative adversarial network including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of an additional realism assessment of at least one specific feature derived from the corresponding data including an application of at least one deterministic function.

A system is thus provided according to an example embodiment of the present invention for training a generative adversarial network, the discriminator being designed also to evaluate expert knowledge, with which system the resource consumption for training the corresponding generative adversarial network may be reduced. The application of at least one deterministic function in the corresponding discriminator has the advantage that it does not have to be trained separately, and so the overall training process becomes more stable and reproducible. This in turn results in shorter training times and a lower resource consumption for training the generative adversarial network. Moreover, compared with conventional methods for training such a generative adversarial network, a greater accuracy is achieved with the same training data, especially since, by selecting specific features that are of interest, a user is able to adjust the distribution of these features particularly well to the distribution of the data.

The application of at least one deterministic function for each of the at least one specific feature may in turn include an evaluation of a distance between at least one distribution characterizing the corresponding specific feature and at least one distribution characterizing the corresponding feature derived from the corresponding data. Since algorithms for determining or approximating a distance between distributions are available, the application of the at least one deterministic function may thus be based on conventional and commonly used algorithms without the need for laborious and complex adjustments.

Moreover, according to an example embodiment of the present inventio, the system may further include a memory in which, for each of the at least one specific feature, at least one distribution for the corresponding feature is stored, and the training of the generative adversarial network in the training unit for each of the at least one specific feature in turn including an adjustment of the at least one distribution for the corresponding feature in each iteration step based on the corresponding data in order to generate at least one adjusted distribution, and, for each of the at least one specific feature, the performance of the additional realism assessment including an evaluation of a distance between the corresponding at least one adjusted probability distribution and an empirical probability distribution of the at least one specific feature. Storing at least one distribution in this way proves advantageous particularly when training the generative adversarial network on the basis of batches or subsets of the training data, since values for the at least one specific feature derived purely from the corresponding batch are possibly imprecise or inadequate.

Moreover, according to an example embodiment of the present invention, the generative adversarial network may in turn be trained to generate vehicle variables of a motor vehicle, or the training data may be sensor data representing corresponding vehicle variables. The training of the generative adversarial network may thus be based on conditions outside the actual data processing system on which the generative adversarial network is trained.

The vehicle variables may be a speed of a motor vehicle, an acceleration of a motor vehicle, or vehicle emissions, for example.

Furthermore, a further specific embodiment of the present invention also provides a system for controlling a controllable system, the system comprising a modeling unit, which is designed to model a profile for controlling the controllable system, the profile being modeled by a generative adversarial network and the generative adversarial network having been trained using a system for training a generative adversarial network as described above, and a control unit, which is designed to control the controllable system based on the modeled profile for controlling the controllable system.

A system for controlling a controllable system is thus provided according to an example embodiment of the present invention which is based on a generative adversarial network that was trained using a system for training a generative adversarial network, the discriminator being designed also to evaluate expert knowledge, and at the same time the resource consumption for training the corresponding generative adversarial network being able to be reduced. The application of at least one deterministic function in the corresponding discriminator has the advantage that it does not have to be trained separately, and so the overall training process becomes more stable and reproducible. This in turn results in shorter training times and a lower resource consumption for training the generative adversarial network. Moreover, compared with conventional methods for training such a discriminator, a greater accuracy is achieved with the same training data, especially since, by selecting specific features that are of interest, a user is able to adjust the distribution of these features particularly well to the distribution of the data.

Furthermore, a further specific embodiment of the present invention also provides a computer program having program code for executing a method for training a generative adversarial network as described above when the computer program is run on a computer.

Furthermore, a further specific embodiment of the present invention also provides a computer-readable data carrier containing program code of a computer program for executing a method for training a generative adversarial network as described above when the computer program is run on a computer.

A computer program and a computer-readable data carrier are thus provided with which a generative adversarial network may be trained, the discriminator being designed also to evaluate expert knowledge, and at the same time the resource consumption for training the corresponding generative adversarial network being able to be reduced. The application of at least one deterministic function in the corresponding discriminator has the advantage that it does not have to be trained separately, and so the overall training process becomes more stable and reproducible. This in turn results in shorter training times and a lower resource consumption for training the generative adversarial network. Moreover, compared with conventional methods for training such a generative adversarial network, a greater accuracy is achieved with the same training data, especially since, by selecting specific features that are of interest, a user is able to adjust the distribution of these features particularly well to the distribution of the data.

In summary, it is noted that the present invention provides a method for training a generative adversarial network, particularly a method for training a generative adversarial network to model a profile for controlling a controllable system, which is more stable compared with conventional methods for training a corresponding generative adversarial network and with which computing time and resources for training the generative adversarial network may be saved.

Example embodiments and developments of the present invention disclosed herein may be combined with one another in any way.

Further possible embodiments, developments and implementations of the present invention also include not explicitly mentioned combinations of features of the present invention described above or below with respect to the exemplary embodiments.

### BRIEF DESCRIPTION OF THE DRAWINGS

The figures are intended to convey a greater understanding of the specific example embodiments of the present invention. They illustrate specific embodiments and in combination with the description serve to clarify principles and concepts of the present invention.

Other specific embodiments and many of the specified advantages may be found in the figures. The illustrated elements of the figures are not necessarily shown to scale in relation to one another.

### BRIEF DESCRIPTION OF THE DRAWINGS

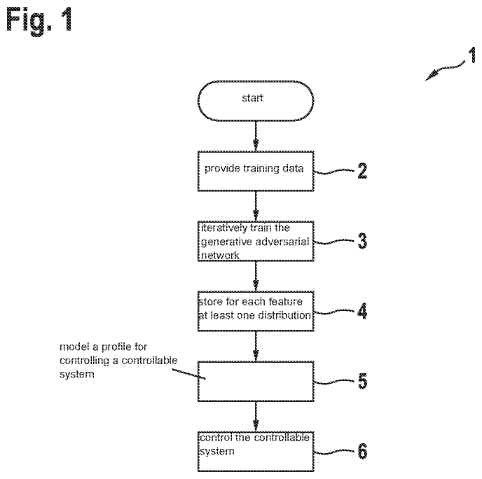

FIG. 1 shows a flow chart of a method for controlling a controllable system according to specific example embodiments of the present invention.

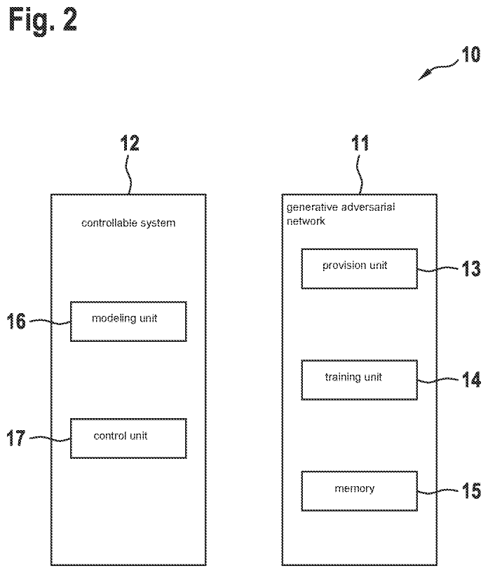

FIG. 2 shows a schematic block diagram of a system for controlling a controllable system according to specific example embodiments of the present invention.

In the figures, identical or functionally identical elements, parts or components are denoted by the same reference signs unless otherwise indicated.

### DETAILED DESCRIPTION OF EXAMPLE EMBODIMENTS

FIG. 1 shows a flow chart of a method for controlling a controllable system 1 according to specific example embodiments of the present invention.

For example, if a driving behavior of a motor vehicle is to be learned in a model or algorithm of machine learning or is to be specified thereby, generative adversarial networks are often trained for that purpose. A corresponding generative adversarial network may specify the speed evolution along a route, for example, or generate a corresponding control signal, on the basis of which a motor vehicle may subsequently be controlled.

A generative adversarial network is generally understood to be a model of machine learning based on two interconnected neural networks. The first neural network, the generator, generates data which initially consist only of random statistical noise.

The second neural network, the discriminator, analyzes or classifies the data generated by the first neural network, the discriminator being trained with true or real data, known as ground truth information, to enable it to evaluate these data. The generative adversarial network is usually trained by way of an iterative procedure, the generator and the discriminator being trained alternately or in each iteration step. The aim is to ensure that the trained generative adversarial network is subsequently able to mimic real-world conditions as accurately as possible.

If, for example, a speed evolution along new road sections is to be learned, then labeled training data, including speed profiles recorded while driving motor vehicles along these sections, for example, are first provided, one of these labeled training data being selected at random and the generator being trained on the basis of the selected training data. A speed profile generated by the generator is then compared in the discriminator with corresponding ground truth information, the discriminator providing a cost function for training the generator. The discriminator is usually designed to output the value 1 if the speed profile generated by the generator deviates from the corresponding ground truth information by less than a predefined limit, and otherwise to output a value that is less than 1 and tends closer to zero as the deviation increases.

In addition, the discriminator may also be designed to verify that certain features, for example a speed after 10 seconds, or an average speed, or a distribution of the acceleration if the speed is below a predefined threshold for the speed, are matched as accurately as possible in the generated speed profile.

The comparison of the generated speed profile with the ground truth information corresponding to these certain features in the discriminator is based on additional neural networks, each of which has to be trained in parallel with the generator. A neural network is usually provided for each of the certain features, requiring training in each case. The disadvantage of this, however, is that it makes the overall training of the generative adversarial network less stable and less reproducible. It also results in longer training times and an additional resource consumption for training the generative adversarial network. There is thus a need for methods for training a generative adversarial network in which the discriminator is designed also to evaluate expert knowledge and with which at the same time the resource consumption for training the corresponding generative adversarial network may be reduced.

FIG. 1 shows a method comprising a step 2 of providing training data for training the generative adversarial network, the generative adversarial network having a generator and a discriminator, and a step 3 of iteratively training the generative adversarial network based on the training data, the training of the generative adversarial network including an alternating training of the generator and the discriminator based on the training data, the training of the generator including a training of the generator based on the training data and results of realism checks performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of an additional realism assessment of at least one specific feature derived from the corresponding data including an application of at least one deterministic function.

The application of at least one deterministic function has the advantage that it does not have to be trained separately, and so the overall training process becomes more stable and reproducible. This in turn results in shorter training times and a lower resource consumption for training the generative adversarial network. Moreover, compared with conventional methods for training such a generative adversarial network, a greater accuracy is achieved with the same training data, especially since, by selecting specific features that are of interest, a user is able to adjust the distribution of these features particularly well to the distribution of the data.

In summary, therefore, a method for training a generative adversarial network is provided in which the discriminator is designed also to evaluate expert knowledge and with which the resource consumption for training the corresponding generative adversarial network may be reduced.

In particular, FIG. 1 shows a method for training a generative adversarial network which avoids the need for neural networks requiring additional training to verify the specific features.

The deterministic function is in particular a deterministic and differentiable function. In addition, the deterministic function may be designed to verify whether the discriminator is assuming that a feature derived from the corresponding generated data is ground truth information.

According to the specific embodiments of FIG. 1, the application of at least one deterministic function for each of the at least one specific feature further includes an evaluation of a distance between a distribution characterizing the corresponding specific feature and a distribution characterizing the corresponding feature derived from the corresponding data.

The distances may be determined here on the basis of a total variation of the mean quadratic deviation, for example. Furthermore, if the at least one specific feature and the corresponding feature derived from the corresponding data are distributions within a certain timeframe, then the distances may additionally be ascertained on the basis of corresponding estimates of the densities or density distributions, based for example on corresponding kernel density estimators.

Method 1 may additionally include a training of the generative adversarial network based on individual batches.

According to the specific embodiments of FIG. 1, method 1 further includes a step 4 of storing, for each of the at least one specific feature, at least one distribution for the corresponding specific feature, the distribution for the corresponding feature being adjusted in each iteration step based on the corresponding data in order to generate an adjusted distribution, and, for each of the at least one specific feature, the performance of the additional realism assessment including an evaluation of a distance between the corresponding at least one adjusted probability distribution and an empirical probability distribution of the at least one specific feature.

In particular, the at least one distribution or basic distribution may be based on an estimate of densities which characterizes the entire training data set and which, in each iteration step, may be adjusted to the corresponding iteration step by corresponding weighting of the estimate of densities characterizing the entire training data set and of a density distribution based on the batch processed in the corresponding iteration step, or by corresponding smoothing of the estimate of densities characterizing the entire training data set. This in turn leads to a faster convergence of the method.

According to the specific embodiments of FIG. 1, the training data additionally include sensor data, particularly sensor data representing vehicle variables of a motor vehicle.

The sensor data may in particular be Global Positioning System (GPS) data recorded during journeys made with correspondingly oriented motor vehicles, and speed values of the corresponding motor vehicles recorded at the same time, for example via corresponding system interfaces.

As FIG. 1 shows, method 1 additionally includes a step 5 of modeling a profile for controlling a controllable system based on the previously trained generative adversarial network and a step 6 of controlling the controllable system based on the modeled profile for controlling the controllable system.

According to the specific embodiments of FIG. 1, the modeled profile is in turn a predefined speed evolution when traveling along a road section or route with a motor vehicle and, correspondingly, the controllable system is a motor vehicle. In particular, the speed of the motor vehicle may be controlled on the basis of a control signal based on the modeled profile.

Moreover, the controllable system may also be other computer-controllable robotic systems, however, such as household appliances, power tools, production machines, personal assistants, or access control systems.

FIG. 2 shows a schematic block diagram of a system for controlling a controllable system 10 according to specific example embodiments of the present invention.

As shown in FIG. 2, system 10 comprises a system for training a generative adversarial network 11, the generative adversarial network having a generator and a discriminator, and a system for controlling the controllable system 12, the system for controlling the controllable system 12 being designed to model a profile for controlling a controllable system, the profile being modeled by a generative adversarial network and the generative adversarial network having been trained using the system for training a generative adversarial network 11.

As further shown in FIG. 2, the system for training a generative adversarial network comprises a provision unit 13, which is designed to provide training data for training the generative adversarial network, and a training unit 14, which is designed to train the generative adversarial network iteratively based on the training data, the training of the generative adversarial network including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of an additional realism assessment of at least one specific feature derived from the corresponding data including an application of at least one deterministic function.

The provision unit may in particular be a receiver which is designed to receive corresponding sensor data. The training unit may further be realized on the basis of a code that is stored in a memory and is executable by a processor, for example.

According to the specific embodiments of FIG. 2, the application of at least one deterministic function during the training of the generative adversarial network in training unit 14 for each of the at least one specific feature includes an evaluation of a distance between at least one distribution characterizing the corresponding specific feature and at least one distribution characterizing the corresponding feature derived from the corresponding data.

According to the specific embodiments of FIG. 2, system 11 further includes a memory 15 in which, for each of the at least one specific feature, at least one distribution for the corresponding feature is stored, the training of the generative adversarial network in training unit 14 for each of the at least one specific feature including an adjustment of the stored distribution for the corresponding feature in each iteration step based on the corresponding data or on the training data used in the corresponding iteration step, in order to generate at least one adjusted distribution, and, for each of the at least one specific feature, the performance of the additional realism assessment including an evaluation of a distance between the corresponding at least one adjusted probability distribution and an empirical probability distribution of the at least one specific feature.

The training data in turn additionally include sensor data, particularly sensor data representing vehicle variables of a motor vehicle.

As FIG. 2 additionally shows, the system for controlling a controllable system 12 includes a modeling unit 16, which is designed to model a profile for controlling the controllable system, the profile being modeled by a generative adversarial network and the generative adversarial network having been trained using the system for training a generative adversarial network 11, and a control unit 17, which is designed to control the controllable system based on the modeled profile.

The modeling unit may be realized on the basis of a code that is stored in a memory and is executable by a processor, for example. The control unit may further be realized on the basis of corresponding actuators and/or code that is stored in a memory and is executable by a processor, for example.

The system for controlling a controllable system 10 may additionally be designed to carry out a method described above for controlling a controllable system.

What is claimed is:

1. A method for training a generative adversarial network, the generative adversarial network having a generator and a discriminator, and the method comprising the following steps:
providing training data for training the generative adversarial network; and
iteratively training the generative adversarial network based on the training data, the training of the generative adversarial network including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of the additional realism assessment of at least one specific feature derived from the corresponding data including an application of at least one deterministic function.

2. The method as recited in claim 1, wherein the application of at least one deterministic function for each specific feature of the at least one specific feature includes an evaluation of a distance between at least one distribution characterizing the specific feature and at least one distribution characterizing the specific feature derived from the corresponding data.

3. The method as recited in claim 2, wherein the method further comprising, for each specific feature of the at least one specific feature storing at least one distribution for the specific feature, the at least one distribution for the specific feature being adjusted in each iteration step based on the corresponding data in order to generate at least one adjusted distribution, and, for each specific feature of the at least one specific feature, the performance of the realism assessment including an evaluation of a distance between the corresponding at least one adjusted distribution and an empirical probability distribution of the at least one specific feature.

4. The method as recited in claim 1, wherein the generative adversarial network is trained to generate vehicle variables of a motor vehicle.

5. A method for controlling a controllable system, the method comprising the following steps:
modeling a profile for controlling the controllable system, the profile being modeled by a generative adversarial network having a generator and a discriminator, and the generative adversarial network having been trained by:
providing training data for training the generative adversarial network, and
iteratively training the generative adversarial network based on the training data, the training of the generative adversarial network including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of the additional realism assessment of at least one specific feature derived from the corresponding data including an application of at least one deterministic function; and
controlling the controllable system based on the modeled profile for controlling the controllable system.

6. A system for training a generative adversarial network, the generative adversarial network having a generator and a discriminator, and the system comprising:
a provision unit configured to provide training data for training the generative adversarial network; and
a training unit configured to train the generative adversarial network iteratively based on the training data, the training of the generative adversarial network in the training unit including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of the additional realism assessment of at least one specific feature derived from the corresponding data including an application of at least one deterministic function.

7. The system as recited in claim 6, wherein the application of at least one deterministic function for each specific feature of the at least one specific feature includes an evaluation of a distance between at least one distribution characterizing the specific feature and at least one distribution characterizing the specific feature derived from the corresponding data.

8. The system as recited in claim 7, wherein the system further comprises a memory in which, for each specific feature of the at least one specific feature, at least one distribution for the specific feature is stored, and the training of the generative adversarial network in the training unit for each specific feature of the at least one specific feature including an adjustment of the at least one distribution for the specific feature in each iteration step based on the corresponding data in order to generate at least one adjusted distribution, and, for each specific feature of the at least one specific feature, the performance of the additional realism assessment including an evaluation of a distance between the corresponding at least one adjusted distribution and an empirical probability distribution of the at least one specific feature.

9. The system as recited in claim 6, wherein the generative adversarial network is trained to generate vehicle variables of a motor vehicle.

10. A system for controlling a controllable system, comprising:
a modeling unit configured to model a profile for controlling the controllable system, the profile being modeled by a generative adversarial network and the generative adversarial network having a generator and a discriminator, the generative adversarial having been trained using a system for training including:
a provision unit configured to provide training data for training the generative adversarial network, and
a training unit configured to train the generative adversarial network iteratively based on the training data, the training of the generative adversarial network in the training unit including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of the additional realism assessment of at least one specific feature derived from the corresponding data including an application of at least one deterministic function; and
a control unit configured to control the controllable system based on the modeled profile for controlling the controllable system.

11. A non-transitory computer-readable data carrier on which is stored program code of a computer program for training a generative adversarial network, the generative adversarial network having a generator and a discriminator, and the program code, when executed by a computer, causing the computer to perform the following steps:
providing training data for training the generative adversarial network; and
iteratively training the generative adversarial network based on the training data, the training of the generative adversarial network including an alternating training of the generator and the discriminator based on the training data, the training of the generator including a training of the generator based on the training data and results of realism assessments performed by the discriminator, and the training of the generative adversarial network in each iteration step including a generation of corresponding data by the generator, a performance of a realism assessment of the corresponding data by the discriminator, and a performance of an additional realism assessment of at least one specific feature derived from the corresponding data by the discriminator, and the performance of the additional realism assessment of at least one specific feature derived from the corresponding data including an application of at least one deterministic function.
